(19) United States
(12) Patent Application Publication
(10) Pub. No.: US 2008/0077436 A1
(43) Pub. Date: Mar. 27, 2008

(54) HOME BASED HEALTHCARE SYSTEM AND METHOD

(75) Inventor: Rajiv Muradia, Ottawa (CA)

Correspondence Address: MERCHANT & GOULD PC, P.O. BOX 2903, MINNEAPOLIS, MN, 55402-0903, US

(73) Assignee: Igeacare Systems Inc., Richmond Hill (CA)

(21) Appl. No.: 11/757,256

(22) Filed: Jun. 1, 2007

Related U.S. Application Data
(60) Provisional application No. 60/809,806, filed on Jun. 1, 2006.

(51) Int. Cl. G06Q 50/00

(52) U.S. Cl. 705/2

(57) ABSTRACT

Disclosed are patient health systems and methods for managing health care plans that collect data concerning patient health and in response thereto automatically updates or selects an alternative care plan. The system also comprises systems and methods for performance of remote health care in which a skilled medical advisor such as a doctor interacts with a patient remotely. The system and method of managing health care plans involves collecting information regarding a patient's environment, physiological measurements, and compliance with a health care plan. The data collected is processed in view of an existing medical care plan in order to facilitate automatic updating of the current care plan or selection of a new plan based on providing the information to a remote server system.

### CROSS-REFERENCE TO RELATED APPLICATIONS

This patent application claims the benefit of U.S. Provisional Patent Application No. 60/809,806 emitted “HOME BASED HEALTHCARE SYSTEM AND METHOD,” filed on Jun. 1, 2006 and expressly incorporated herein by reference.

### FIELD OF THE INVENTION

The invention relates to health care plans that are carried out at home. More specifically, the invention relates to a system and method of managing health care plans that collect data concerning patient health and in response thereto automatically updates or selects an alternative care plan.

### BACKGROUND

In recent years, the costs of providing high quality health care have increased to the point that, in many countries, health care costs represent a significant portion of state expenditures. In some jurisdictions private health care companies provide health care services. In both cases increasing costs of skilled medical professionals, medical test equipment and pharmaceuticals have resulted in strong desire to find inexpensive alternatives.

One way to provide improved health care without the cost of keeping patients in a hospital is to have patients return home and complete their health care program at home. Such systems take advantage of inexpensive medical testing sensors such as those described by Boecker et al. in U.S. Pat. No. 6,966,880. In some cases, it remains necessary to monitor specific medical criteria of patients and the prior art teaches providing medical test equipment in the home of a patient, monitoring the patient with the medical test equipment to generate medical data, providing the medical data to a medical service and when the data is indicative of a complication, providing an alarm signal. Such a system is taught by Ridgeway in U.S. Pat. No. 5,976,975.

Clearly there are a very large number of medical treatments that are suitable for using such methods. For example, in U.S. Pat. No. 6,379,301 by Worthington, a system for monitoring and maintaining a history of blood sugar readings is used to predict a future blood glucose level. When the future blood glucose level is outside a predetermined range, the system provides recommended corrective action based upon sensed data and the diabetic user's known sensitivity to insulin.

Similarly, in U.S. Pat. No. 5,987,519 Peifer et al. teach a telemedicine system that relies upon communication with the patient. The system according to Peifer serves to ensure that the data is provided in a standardized fashion such that a variety of different medical sensing devices provide data to a single system in a coherent fashion.

The prior art teaches a variety of useful home care techniques, however, it will be clear to one of skill in the medical arts that a variety of complications are easily envisioned. For example, a program for monitoring the diet and exercise of a first patient is not necessarily well suited to another patient. In addition, there are instances where a patient recovering from a first ailment has other complicating medical conditions. Clearly, a doctor aware of such complications is likely to recommend that such a patient remain under supervised care to ensure a proper recovery. While this is a national course of action it does represent a relatively expensive process.

It would be beneficial to provide an enhanced remote medical system that allows patients and other users to monitor various parameters associated with their health and provide useful medical responses thereto. In addition, it would be beneficial to provide a flexible home health care system.

### SUMMARY

Consistent with embodiments of the invention, system and method of managing health care plans that collect data concerning patient health and in response thereto automatically updates or selects an alternative care plan. The system also comprises systems and methods for performance of remote health care in which a skilled medical advisor such as a doctor interacts with a patient remotely. The system and method of managing health care plans involves collecting information regarding a patient's environment, physiological measurements, and compliance with a health care plan. The data collected is processed in view of an existing medical care plan in order to facilitate automatic updating of the current care plan or selection of a new plan based on providing the information to a remote server system.

The system that facilitates remote health care is comprised of a patient health system operatively connected to a health care provider analysis system through a communications network. The patient health system is comprised of patient station for data input and a plurality of sensors operatively connected to the patient station and configured to collect and facilitate the recording of patient environmental and physiological data. The plurality of sensors and patient station are located proximate the patient. The patient station is operatively coupled to a communications network that facilitates transmission of data representative of a patient's environmental and physiological data to the health care provider analysis system that is located remote from the patient health system. The communications network may be comprised of any data transmission medium such as, for example a broadband network, a wireless network, cellular network, satellite network or dial up network. The method implemented by the system involves the providing of a medical treatment plan to a patient and the automatic update thereof or selection of an alternate medical treatment plan in response to the processing of data acquired from a plurality of active and passive sensors in a home of a patient as part of a patient's medical plan.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description and include systems and methods for managing health care plans that collect data concerning patient health and in response thereto automatically updates or selects an alternative care plan.

### BRIEF DESCRIPTION OF THE DRAWINGS

The invention is now described with reference to the drawings in which

FIG. 1 is a diagram of an embodiment of the invention;

FIG. 2A, is an illustration of the process and flow of data that occurs during patient use of the system illustrated in FIG. 1;

FIG. 2B, is further illustration of the process and flow of data that occurs during patient use of the system illustrated in FIG. 1;

FIG. 3, is an illustration of the process and flow of data that occurs during care provider use of the system illustrated in FIG. 1.

FIG. 4A is an illustration of part of the operation of the medical plan module;

FIG. 4B is an illustration of part of the operation of the medical plan module;

FIG. 4C is an illustration of part of the operation of the medical plan module;

FIG. 4D is an illustration of part of the operation of the medical plan module;

FIG. 5, illustrates a login screen;

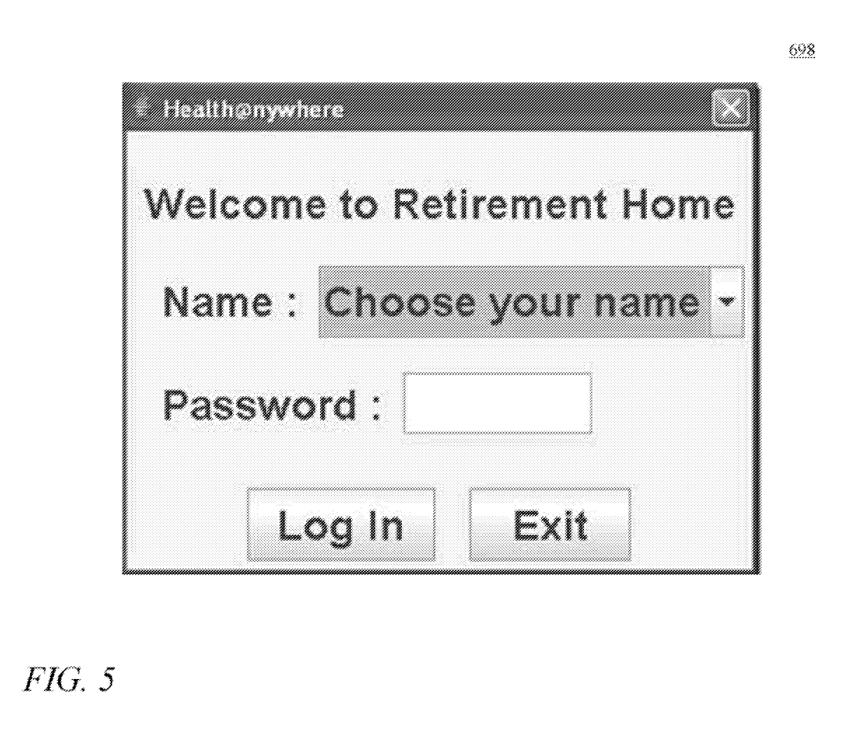

FIG. 6, illustrates an access welcome screen;

FIG. 7, illustrates a blood sugar monitoring screen;

FIG. 8, illustrates a blood sugar monitoring screen;

FIG. 9, illustrates an instruction screen;

FIG. 10, illustrates a video box;

FIG. 11, illustrates a report screen; and

FIG. 12, illustrates a graph of measurements

### DETAILED DESCRIPTION OF THE INVENTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the invention. Instead, the proper scope of the invention is defined by the appended claims.

The present invention relates to systems and methods in the remote health care environment that facilitate the management of health care plans and the automatic update and or selection of a new health care plan in response to the processing of patient health and environmental data collected from a patient health station. Systems and methods consistent with embodiments of the present invention may be used to transmit data representative of a patient's physiological and environmental measurements collected by a patient health station to which a plurality of active and passive sensors are operatively connected in order to facilitate collection and transmission of patient environment and physiological data. The system and method may be facilitated by providing active and passive sensors proximate the patient to sense patient physiological data information about the patient's environment such as air quality, location within the home etc. Environmental sensors are passive, meaning they do not require a patient's engagement in order to facilitate retrieval and loading of environmental data onto the patient health station. Active sensors are sensors such as a stethoscope or a blood glucose meter. These devices are classified as active sensors because they require a patient's engagement in order to facilitate retrieval and loading of patient physiological data onto the patient health station.

The patient health station processes the data representative of a patient's environment and physiological measurements to determine if the data is within predetermined acceptable ranges. These ranges are defined a patient medical plan. Data representative of a patient's environment and physiological measurements that are not within acceptable ranges are flagged with an indicator and stored in a memory buffer. The data is flagged with an indicator so that a health care provider can easily pinpoint such data during assessment. Upon a determination by the patient health station that the communications medium between the patient health station and the health care provider analysis system is sufficiently stable, the data within the memory buffer is transmitted from the patient health station to the health care provider analysis system in gradual and orderly fashion. Gradual and orderly data transmission helps to facilitate recovery and redistribution of incomplete data transmissions resulting from communication network service interruptions. The data transmitted is stored on a remote central server within the health care provider analysis system where it is processed by a remote server in order to determine whether the patient data is indicative of a first condition and whether the medical plan is appropriate. The system automatically selects an alternative medical plan in response to patient medical data processed in accordance with a medical plan decision module.

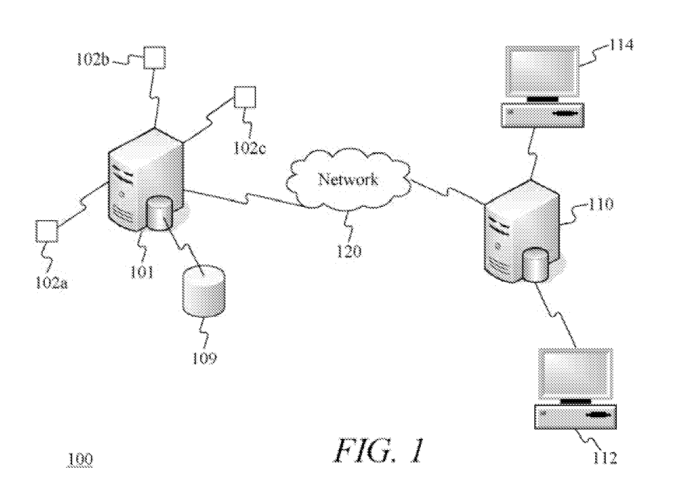

Consistent with an embodiment of the present invention, the aforementioned patient health station and health care provider analysis system which are operatively coupled via a communications network may be implemented in the embodiments illustrated in FIG. 1. Referring to FIG. 1, a system according to the first embodiment of the invention is shown. The system 100 supports communication between a patient health station 101 and a central server 110 of a health care provider or data hosting organization that is remote to the patient health station 101 and operatively connected via communications medium 120. The patient health station 101 is operatively connected to a set of active and passive sensors 102a, 102b, 102c disposed in a patient's living quarters for the purpose of monitoring the environment of the patient's living quarters and monitoring the patient's physiological measurements. The set of sensors communicate with the patient health station 101 which in turn communicates with the central server that is accessible by a medical professional. In use, following installation and synchronization of the set of sensors 102a, 102b, 102c with the patient health station 101, the sensors are activated and facilitate transmission of patient environmental and physiological measurements to the central server 110. When data representative of the patient environmental and physiological measurements is indicative of the worsening of a healthcare condition and or the initiation of previously unknown medical conditions, the medical professional whom has access to the patient health data may be notified and in response may contact the patient.

In use, the patient follows a medical plan and, in accordance with the medical plan, provides medical data from the set of sensors 102a, 102b, and 102c to the patient health station 101. Thus, for a patient following a diet, the sensor 102a likely comprises a scale. Optionally, the sensor 102a may comprise other sensors which may be used for the collection of data associated with a patient's diet. For example, if the patient has diabetes then it would be beneficial to provide blood glucose information from a suitable sensor system. A person of skill in the art will appreciate that there are a wide variety of medical sensors that are sufficiently inexpensive that an individual can have them conveniently available. Additionally, the data acquired from one or a set of sensors 102a, 102b, and 102c is optionally communicated to the patient health station 101 in any of a variety of ways. For example, if the sensor 102a is a scale then the patient might record their measured weight and provide the data by inputting it into the patient health station 101. Alternatively, the weight scale optionally comprises a data link to the patient health station 101 that automatically provides the data when the weight scale is used. Such a data link is optionally supported by Bluetooth technology. A person of skill in the art will appreciate that a wide variety of active and passive sensors and systems for transferring data from such sensors to a suitable computing device are easily contemplated. The patient health station 101 stores data associated with the patient such that previous readings from a sensor 102a, 102b, 102c are dated and available for later use. The data is stored in a non-volatile memory 109 of the patient health station 101 and is optionally stored in a separate computing device (not shown) such that the data is still available should the memory with the patient health station 101 suffer a catastrophic failure. Optionally, the stored data is encrypted.

In use, the patient, optionally with the assistance of a medical professional, chooses a medical treatment plan that involves monitoring certain data about the patient. During the course of treatment, the monitored data indicates a likelihood of either an inability to safety continue the plan or a likelihood of another medical condition. When this occurs, the medical professional and the patient discuss the patient's medical situation and provide the patient with another medical plan. Thus, in the case of the person dieting, the patient provides data indicative of a medical complication. The medical professional and the patient discuss the data. In addition, the medical professional questions the patient to obtain additional data. If the medical professional requires additional data to confidently make an accurate diagnosis then additional tests are carried out. In this way, the patient who is dieting may show symptoms of having diabetes. In this situation, it is important to confirm whether or not the patient truly is diabetic. Assuming that the patient does indeed have diabetes then the patient is optionally provided a diet plan that is more appropriate for a diabetic. Optionally, the medical professional introduces another medical professional who specializes in diabetes into the treatment plan. Further optionally, once the specialist is involved, the first medical professional withdraws from the medical treatment plan. In this way, the treatment plan is always patient focussed. The data associated with the treatment plan is always maintained. Clearly, redundant medical tests are avoided when the patient is transferred to the specialist. In addition, should it be decided that the patient visit the doctor for tests it is not necessary to test the patient for those tests that are currently being monitored at home other than to ensure that the home testing system is accurate.

Thus, in accordance with the first embodiment of the invention, the process of changing a home health care plan is simplified. In addition, changing a home health care plan that is supervised by a skilled medical professional does not require that the patient and the medical professional meet face to face. It is also contemplated that the patient and medical professional do not have to meet at all, as the system further includes a medical plan decision module that automatically selects an alternative medical plan in response to patient medical data processed by the central server 110.

Prior art systems teach the use of home medical data acquisition as a supplement to visiting a doctor or other medical professional. In accordance with the prior art, when the doctor suspects that the patient has another medical condition, the patient is brought to a hospital or other medical facility and tested. The data acquired in home testing is used for the purpose of generating a suspicion of a medical condition that is only verified in a conventional manner. Once the results of the tests are provided, the patient is optionally transferred to a specialist. Ideally, a complete medical file is provided to the specialist however, in many cases this does not occur. Thus, additional costs are introduced as the specialist is likely to repeat whatever tests have already been completed.

Ideally, every healthcare system is very efficient. Unfortunately, in many cases it is not simply due to the costs of carrying out simple tests. For example, it is common practice to measure the weight of a patient when they go to see a doctor. The cost of weighing a patient is easily overlooked although, in many cases, this is something that the patient does anyway. When the cost of a simple test is multiplied by millions of patients and their visits to the doctor it is apparent that even a small benefit to the efficiency of medical testing provides a tremendous benefit to the health care system. Thus, using a system according to the invention, prior to a conventional medical check-up, a user conducts what tests they can at home and the data is transmitted to their doctor's office. Optionally, the patient stores the data on a non-volatile storage medium and takes it with them to the doctor's office. Further optionally, a given medical testing system is used by a plurality of patients in a same household. Thus, in a family of five there is only one scale. When each of the family members has a different weight it is a simple matter to determine which family member is which when they go to weight themselves. If two or more of the family members have roughly equivalent weight then it is a simple matter to provide a personal identifier when being weighed. Alternatively, a patient has the option of editing their medical data to ensure that it is assigned to them. Thus, when the scale provides readings, it transmits them to a personal computing device in the residence of the patient and, should a reading not be associated with the patient, the patient verifies their data. The correctly assigned data is then provided to a skilled medical professional.

A person of skill in the art will appreciate that it is common practice to retest a patient for a suspect condition when the patient is transferred from a first doctor to a second doctor. Such a test represents an additional cost to the medical system. The second test is justified to the extent that the first test may have been conducted in a faulty manner. For example, the equipment used in the first test would not yield an accurate result if the equipment was in need of maintenance or calibration. In order to address this health care cost, the system according to invention optionally stores data associated with the testing instruments used to provide medical data associated with the patient. Thus, the medical data comprises additional information such as, the date the medical data was acquired, an identifier of the medical equipment and flag indicative of whether the equipment is in need of service. In this way, when acquired data indicates that the patient may have a serious health condition an overseeing physician reviewing the data may wish to verify the accuracy of the measurement without bringing the patient to their office. A person of skill in the art will appreciate that a skilled lab technician is sufficiently qualified to verify the accuracy of the medical instrument. Thus, in many cases, if a medical facility is unavailable, the accuracy of remotely acquired healthcare data is verified. Additionally, verifying the accuracy of the test instrument this way is often less expensive than ordering a new set of tests. Clearly, if the patient's medical testing equipment is found to be faulty it is desirable to either service it or replace it.

It should be noted that many medical plans routinely are carried out without the supervision of a doctor. A common example of this is dieting, however, a variety of others also exist. Clearly, it is highly recommended that a dieter receive advice from a doctor and dietitian.

Further, it is apparent that the systems and methods of the invention are clearly applicable to preventative medicine. A variety of medical tests that are easily carried out at home are optionally used to diagnose medical conditions before their effects become apparent. As is well understood in the art, it is often the case that early diagnosis provides a much higher likelihood of success as well as reduced cost for a variety of medical procedures.

There are a variety of medical conditions and ailments that are best served by performing medical tests while the patient is experiencing a problem. Often these conditions are temporary. As is well understood in the art it is very beneficial to test a patient when a condition arises and therefore it is often the case that the delays associated with recognising the presence of a medical problem, booking an appointment with a medical professional and then taking test results poor test data. Specifically, for many temporary but recurring conditions it is difficult to isolate the medical problem because the patient appears to be quite healthy when they are tested. Using a system according to the first embodiment of the invention test data is acquired when the patient experiences symptoms. In addition, if the sensor data acquired is insufficient to make a proper medical diagnosis it is a simple matter to provide additional test equipment for use by the patient should the symptoms return.

The present the invention supports the use of a wide variety of passive and active sensors that monitor the patient's environment, certain actions of the patient, and patient physiological measurements. Some passive sensors which may be used in the present invention include sensors that monitor sleep, bathroom visits, bedroom visits, activity monitoring, meal preparation, air quality and patient fall status. A sensor that monitors a patient sleep may be comprised of a pad to detect breathing pattern, or a pad that detects movement during sleep or whether a patient is getting in/out of bed. Such a sensor may be connected via wireless or wired connection. A sensor that monitors bathroom visits may be door contacts, toilet seat contacts. A sensor that monitors bedroom visits may be wired or wireless door contacts. A sensor that monitors the patient's activity level may be sensors throughout the house, such as wired or wireless contacts on doors. A sensor that monitors the patient's meal preparation may be sensors that detect the opening and closing of stove, refrigerator, microwave oven, etc. A sensor that monitors the quality of air in a patient's home may be comprised of a sensor that can monitor a number of different components such as CO2 levels, pollen count etc. A sensor that monitors a patient's fall status detects the position of the body relative to ground. Any of the sensors utilized to monitor patient environment may be connected by hard wire or via wirelessly.

A person of skill in the art will be aware of other sensors that collect data in a passive way that are also useful in assessing the health of an individual. In addition, it is beneficial to acquire data relating to the environment in which the patient lives absent independent of collecting medical information about the patient for the purpose of determining a patient's health. For example, an environmental sensor disposed within a patient's home monitors air quality. If the patient is known to have a breathing disorder such as asthma, then it is valuable to have data relating to the quality of the air that the patient is breathing. Thus, if the patient reports that they are experiencing more difficulty breathing than would be the case usually, that medical professional is able to determine if the problem is likely associated with a recent change in air quality.

A person of skill in the art will also appreciate that the use of specific sensors involves a certain degree of user interaction. For example, a sensor that monitors air quality is likely to support functions that monitor air quality absent input signals from the patient once the sensor is suitably located and configured. In contrast, a scale that the patient stands on to activate requires activation by the patient. Thus, while a scale provides very useful medical information, it is not truly a passive sensor because the patient interacts with the scale in order to provide a reading from the scale. In contrast, while a toilet requires some interaction by the patient, i.e. both use and flushing, that interaction is understood to be common practice associated with normal bodily functions. Clearly, in most technological societies, there is no convenient sanitary alternative to using a toilet and therefore the interaction of the patient and the toilet is understood to be normal practice. In this way, a sensor configured to report the use of a toilet involves no unconventional interaction between the patient and the toilet. In contrast, a person who is not accustomed to standing on a scale may simply forget to do so.

Clearly, the first embodiment of the invention supports determining when a patient should seek skilled medical attention. In addition, the first embodiment of the invention allows an individual to have their health monitored automatically, by a medical professional. The medical professional accesses data within the central server 110 via a workstation 112, 114. In an alternative to the first embodiment of the invention, the server 110 includes non-volatile memory. The non-volatile memory is used to store data in dependence upon information received from the sensors. In this way, the medical professional is able to review a history of data regarding the patient and thereby provide more accurate assessments of the patient's current health.

A person of skill in the art will appreciate that there are a variety of techniques for supporting data transmission from the sensors of the set of sensors 102a, 102b, 102c to the central server 110 are optionally supported. For example, in some cases it is convenient to provide sensors that support wireless data transmission, such as Bluetooth sensors, that may communicate with the patient station 101 which also supports receiving wireless data from the sensors. The patient station 101 having received the wireless data then transmits the data to the central server 110 via network connection 120, which may be for example, an Internet connection. Alternatively, the set of sensors 102a, 102b, and 102c provide data to the patient station 101 that has the capability to send patient data over a cellular network. A variety of different communications infrastructure is optionally used as the communications medium 120. For example, the terminal 101 optionally communicates with the server 110 via a wireless link, an Internet link or a plain old telephone system (POTS).

Optionally, identification data is captured along with the sensor data in order to allow use of the system in a home occupied by more than one individual. For example, a toilet is fit with a weight measure for distinguishing between members of a household. Further optionally, the method is employed in buildings other than homes. For example, in an office building a urinal is fit with a sensor for sensing urine content and with a second sensor for sending identifying information about the origin of the urine.

In addition, the patient station 101 supports additional active sensors such as medical testing equipment, which monitor such things as a heart rate monitor and blood glucose meter, to name a few. Such instruments are designed to support providing measured health information to the central server 110. A person of skill in the art will appreciate that this embodiment of the invention is easily modified to support a wide variety of medical tests.

As FIG. 1 illustrates, the patient station 101 includes a memory buffer 109 disposed electronically proximate the patient station 101. The memory buffer 109 supports receiving data from the sensors 102a, 102b, and 102c. The memory buffer 109 is optionally located within the patient station 101 or external to it. In use, active and passive sensors 102a, 102b, and 102c transmit environmental and patient physiological data to the patient station 101 which facilitates the storage of patient environmental data received in the memory buffer 109. A person of skill in the art will appreciate that the ability to support communications between remote locations is often difficult to achieve in practice, particularly in areas that are not well served. The memory buffer 109 serves to mitigate such problems by storing information associated with the environmental data received from sensors 102a, 102b, 102c and transmitting it to the central server 110 via network connection 120 when the communications network supports such data transfer.

When patient environmental and physiological data is being transmitted between the patient station 101 and the central server 110, the data is stored in the memory buffer 109 and transferred to the central server 110 in a gradual fashion that supports verification of the accuracy of the patient data being provided. In this way, should communication between the patient station 101 and the central server 110 fail, the information regarding the patient environmental data is still available. Optionally, the memory buffer 109 supports downloading of data stored therein via a local communications port, such as a universal serial bus (USB) port. A person of skill in the art will appreciate that buffering and then transmitting the patient data will require more time than simply sending the patient data directly. Clearly, in situations that allow the patient data to be transmitted directly it is still beneficial to temporarily and simultaneously store the patient data in the memory buffer 109 as even robust communications links are subject to temporary reductions in bandwidth and other types of failure. Optionally, the data transmitted is transmitted in a compressed form.

Further optionally, the patient station 101 may include predetermined medical instructions regarding how a patient operates an active sensor such as a stethoscope. When the patient accesses the patient station 101 they identify themselves. The computing device within the patient station 101 interprets data within the non-volatile memory and provides the predetermined medical instructions to the patient in accordance with the data. The patient then operates an active sensor, such as an electronic stethoscope by recording their heartbeat in accordance with the instructions provided. Data within the memory buffer is later transmitted to the central server 110.

In addition, the patient station 101 supports additional active sensors such as medical testing equipment, which monitor such things as a heart rate monitor and blood glucose meter, to name a few. Such instruments are designed to support providing measured health information to the central server 110. A person of skill in the art will appreciate that this embodiment of the invention is easily modified to support a wide variety of medical tests.

The patient station 101 may also include a video screen for providing visual information. In use, the medical professional is able to provide video information to the patient. The information provided to the patient will most likely be in the context of an analysis of all patient medical data which includes data automatically transmitted by the sensors 102a, 102b, and 102c. Thus, should the patient experience some difficulty with a self-administered medical procedure that is performed through the use of active sensors, the medical professional is able to provide the patient relevant instruction both visually and audibly in order to assist the patient. Optionally, the medical professional provides a predetermined video stream to the patient station 101 where the media stream comprises medical instruction information for the purpose of instructing a patient regarding a self administered medical procedure. Further optionally, a set of such procedures are stored in a non-volatile storage memory proximate the server 110.

A person of skill in the art will appreciate that there are a wide variety of techniques for using an active sensor such as a stethoscope. While one embodiment of the invention features a stethoscope that comprises a microphone that supports recording of heartbeat data to an external medium, an alternative stethoscope comprises an electronic microphone that is placed in close proximity to the patient'chest. In an alternative embodiment, the stethoscope comprises an elastic loop with a microphone that the patient positions against their skin proximate the heart with the elastic loop going around the chest. Such an embodiment optionally comprises a tension sensor for providing information regarding the amount of tension used to hold the sensor against the chest. The tension sensor facilitates the sensors ability to provide relatively consistent measurements. Further optionally, video transmission of the patient wearing the stethoscope is recorded and transmitted so that if the stethoscope is poorly located the medical professional will be able to easily verify this and redirect the patient concerning proper positioning.

It will be apparent to one of skill in the art that in many cases it is beneficial to have a medical professional other than a physician review patient environmental data and data captured from other active and passive sensors. Following a review of data, should the medical professional suspect that there is a health problem, they can transmit the relevant portions of data to a physician or other specialist for assessment. In this way, the medical professional and the cardiologist have the opportunity to review the suspect data retrieved from the environment along with data from active and passive sensors. This has the additional benefit of teaching the medical professional the characteristics of a suspect heartbeat.

A person of skill in the art will appreciate that a wide variety of techniques are available to support communication between the patient station 101 and the central server 110. Clearly, the choice of the technologies used is dependent upon a variety of factors, many of which are outside the scope of the present invention. Further, a person of skill in the art will appreciate that the embodiments of the invention presented are intended to be illustrative of the invention and not limiting. Numerous other embodiments of the invention will be apparent to one of skill in the art.

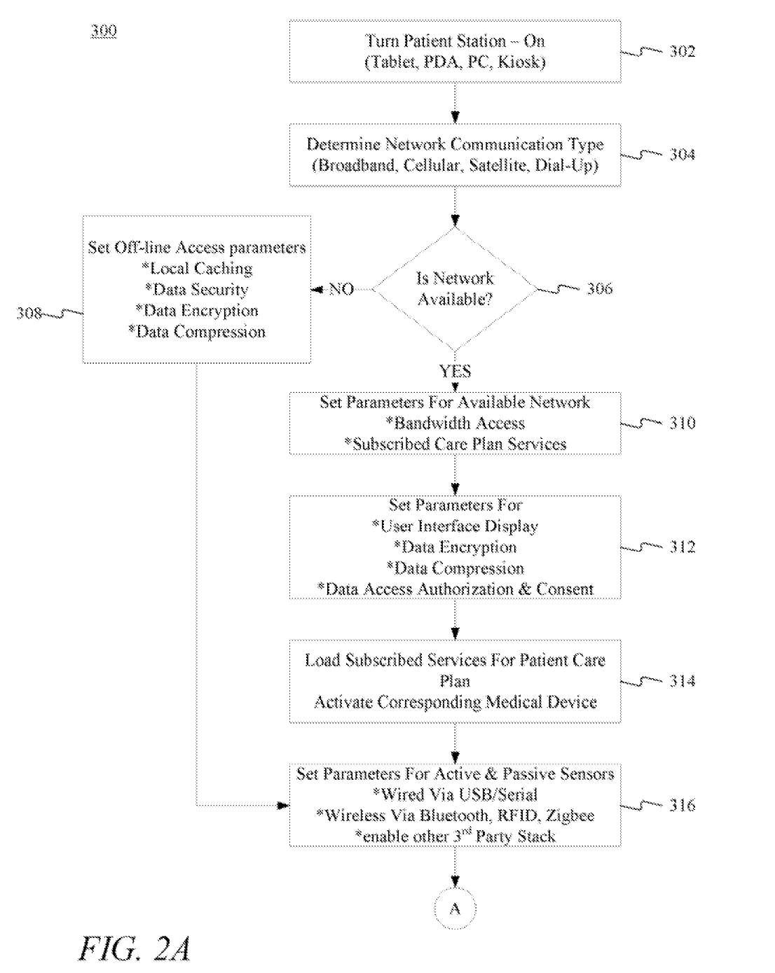

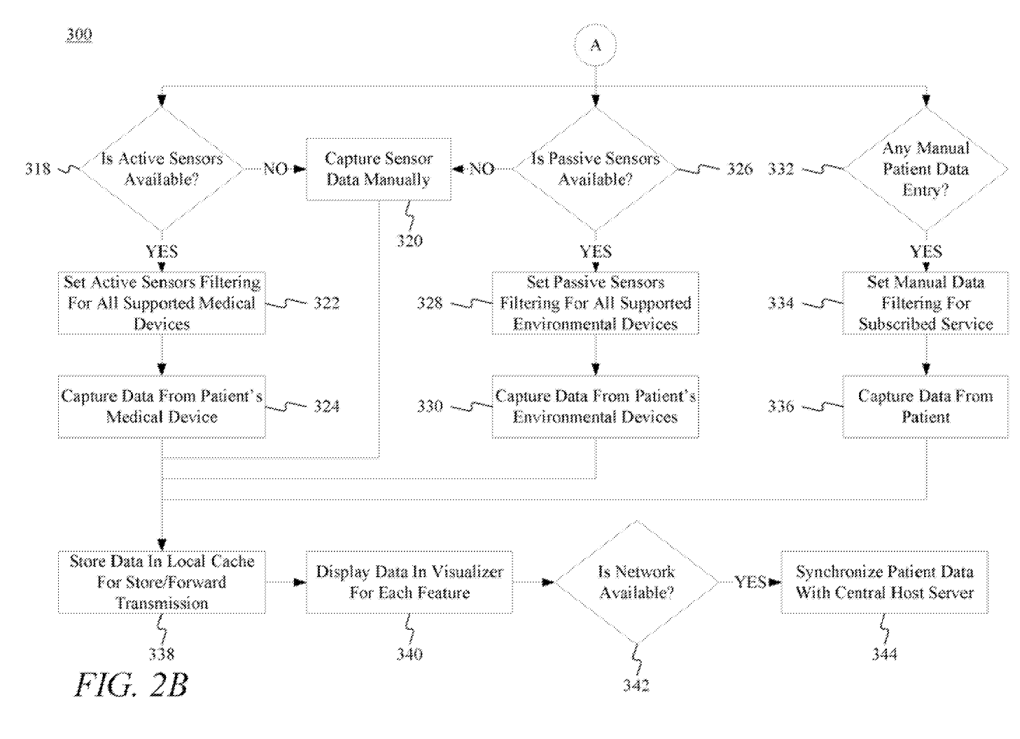

Referring now to FIG. 2A, the patient station which is a remote device utilized to enter patient physiological data remotely, may be any one of the following devices: a table PC, a PDA, a personal computer, a Kiosk, laptop or any other computer-implemented configuration including a display screen, processor and memory. When operating a patient station, initially the device must be turned on 302. Upon activating the patient station, a communications link test is performed 304 by a communications link module to determine the network communication type across which the patient station shall transmit patient data. It is to be understood that the network communication type may be a wide area network that includes dialup (56 k), ISDN, TI DSL, broadband, cellular, satellite, or any other communications medium that facilitates the transmission of data. The communications link module that checks the network communication type performs an assessment of which communication types may be available and also selects the optimal communications network if more than one communications network type is detected. For example, it is contemplated that there may be patient stations that include dialup and broadband network communications. The communications link module that checks the network communication type selects the optimal network communication type and then determines whether the communications network selected is available 306. If the network is not available, the communications link module sets up the patient station to operate in offline mode 308.

During offline mode 308 the patient may still use the patient station, even though there is no network communication between the patient station and the remote healthcare server that functions as a central data repository for patient information. However, the patient may interact with the patient station graphical user interface application to input data manually and to facilitate automatic capture of data from active and passive sensors. Data input during offline mode is locally cached. Offline mode also facilitates setting of security on patient data, configuration of encryption and data compression technology being used. Alternatively, if the communications network is available 306, the patient station sets parameters for transmitting data across the available communications network. The parameters that shall be set are determined by the network communication type. Next, the patient station determines the type of care plan services the patient has access to 310. The care plan services may include services such as video visit, vital signs monitoring, blood pressure monitoring, blood glucose monitoring, blood oxygen monitoring, body weight monitoring, body temperature monitoring, pulmonary function analysis, respiratory monitoring, neurological monitoring, cardiac monitoring, sleep monitoring bathroom visit monitoring, bedroom visit monitoring, activity monitoring (sensors in the house), meal preparation monitoring air quality monitoring, patient fall status monitoring (sensors to detect body up/down position) or any other services that may be available to a patient via the patient workstation. It is to be understood that the care plan services that are active as icons on the patient station shall be configured by the care provider remotely or directly upon the patient station prior to delivery. The patient station is configured for the patient based on the patient's illnesses and the services that a patient may require. For example, if a patient is diabetic, the patient station shall be configured to interface with a glucose meter and a weight scale and have the medication reminder service. By way of further example, if the patient is a cardiac heart failure patient (CHF), the patient station may be configured to interface with a stethoscope as well as an apparatus for capturing the patient's ECG measurements.

Following a determination by the patient workstation that the network is available, a determination is made by the patient station configuration module of the bandwidth for the communications network and the services which may be pushed on that bandwidth 310. Next the system sets the patient station up for user interface display 312. If the net work communication type is dialup, a patient would not be able to facilitate wound management interface, because wound management interface includes a video component. If the network communication is high-speed DSL, wound management is an application which may be engaged because the video component may be streamed via the high-speed DSL connection. For example a patient having diabetes, may subscribe to the wound management service and thereby have an active wound management icon display on the patient station. The wound management service allows wounds to be displayed and recorded by the healthcare provider. Typically during operation, a patient station camera is utilized to facilitate capture of ulcers on the feet of the patient for transmission back to the central server of the healthcare provider system. The images are transmitted from the patient station back to the central server of the healthcare provider system. A nurse stationed at a work station which is connected to the central server may view the images to provide feedback which may be immediate when images are viewed as they are being streamed across the communications network. The images may also be viewed at a later time when the video images are stored in server memory.

Next, the patient station configuration module sets the parameters for user interface display, data encryption, data compression, and data access, authorization and consent 312. The data encryption parameters being utilized is a key pair encryption. A key that is stored on the healthcare provider's server is utilized to encrypt the data. Utilization of key pair encryption guarantees that data transmitted over the communication network cannot be intercepted and viewed by individuals intercepting data being transmitted over the communications network. Data compression is performed to facilitate shrinking of data so that the data can be transmitted on a network having very low bandwidth. For example if the communications network is dial-up, the data may be compressed and transmitted at a faster rate. The compression algorithm is a standard application protocol interface (API). Data access, authorization and consent is the control mechanism whereby the system dictates the individual'who have access to and can actually look at the patient data once it is captured. The data access, authorization and consent parameters define the individuals whom may have access to patient data. Data access, authorization and consent parameters are defined by the patient through the patient station. For example a patient may define the parameters such that his or her pharmacist does not have access to the patient's physiological data representative of the patient's vital signs. However, the pharmacist may have access to data concerning a patient's diet, medication plan and any other data which the patient determines that the pharmacist needs to have access.

Next, services to which the patient subscribes are loaded onto the patient station by loading the icons that correspond to a subscribed service onto the patient 314. Based on the icons loaded onto the patient station, active and passive sensors that correspond to the service icons loaded may be activated by engaging the icons. For example, an icon is loaded onto the patient workstation in order to facilitate glucose monitoring. That icon has to be operatively connected to a sensor, which in this example is an active sensor, such as a glucose monitor. For glucose monitoring interface to be fully functional on the patient station, the glucose monitor must be activated and operatively connected to the patient workstation. In one embodiment operative connection and activation may be performed by Bluetooth communications. Next, parameters are set active and passive sensors 316. Engaging the subscriber service icon causes the parameters for the active and passive sensors to be set 316. It is contemplated that active and passive sensors may be connected or communicating with the patient station via wired USB or serial connections, wireless Bluetooth, RFID or Zigbee communications or any other third party communications protocol. The Bluetooth communications link is performed by pairing the workstation with the active or passive sensor in accordance with normal Bluetooth pairing protocol.

Following the setup of the parameters for active and passive sensors, in accordance with the services associated with a patient, the system tries to determine whether any active or passive sensors are available 318, 326. In the case of a diabetic patient they have engaged the icon for measuring their blood sugar level through use of the glucose monitor, an active sensor. Upon a determination that there are active sensors 318, a filtering mechanism 322 is engaged to make sure that only the proper data is being pulled into the patient workstation. Proper data is data that falls within previously defined minimum and maximum range levels. Data falling within the acceptable range is captured and stored on the patient station. When data received is above or below the range of acceptable data, the data is flagged and saved. An alert is also associated with data that has been flagged and the alert is transmitted to the remote central server and thereby to previously defined individuals to provide notice that something abnormal is occurring with the patient or the active sensors.

Upon a determination that there are passive sensors 326, a filtering mechanism 328 is engaged to make sure that only the proper data is being pulled into the patient workstation. Proper data is data that falls within previously defined minimum and maximum range levels. Data falling within the acceptable range is captured and stored on the patient station. When data received is above or below the range of acceptable data, the data is flagged and saved. An alert is also associated with the data that has been flagged and the alert is transmitted to the remote central server and thereby to previously defined individuals to provide notice that something abnormal is occurring with the patient or the sensors.

The system is also capable of facilitating manual data entry 332. For example if a patient needs to enter their temperature into the patient station, because thermometers are not Bluetooth capable nor do they have USB or any other communications capability, the user must enter data representative of the patient's temperature into the patient station manually. The patient station includes a keypad whereby the patient may enter the value that the patient sees on the medical device. Following a determination that there is data for manual data entry 332, a filtering mechanism 334 is engaged to make sure that only proper data is being pulled into the patient workstation. Proper data is data that falls within previously defined minimum and maximum range levels. Data falling within the acceptable range is captured and stored on the patient station. When data received is above or below the range of acceptable data, the data is flagged and saved. An alert is also attached to the data and the alert is transmitted to the remote healthcare provider system to indicate a potential patient health issue or a problem with the device for which data has been entered.

The patient data captured by the patient station is stored in a local cache for the store forward transmission function 338. The store forward function defines how much of a data stream needs to be stored in order to facilitate safe data transmission in order to allow for the recovery of data which may have been lost during a faulty transmission or service interruption. For example, the amount of data that needs to be stored in the local cache before being forwarded depends on whether data is to be transmitted across a broadband connection network or a dial up connection.

In one embodiment, when the communications network is dial up, data is stored in 10 second groupings and forwarded. When the communications network is broadband, data packets are stored in 39 second blocks and forwarded. The 30 second block of data packets are transmitted across the communications network in an orderly fashion. Patient station data processing includes an algorithm that tracks the data packets being set and includes a verification mechanism for verifying that all data packets transmitted within a 30 second block were received. The verification mechanism is the transmission of an acknowledgement that is sent back to the patient station from the central server following verification by the algorithm that the entire 30 second block of data packets was received. The algorithm determines whether a block of data packets has been received by the size of the block of data packets. For example a first 30 second block of data packets is created then sent, a second 30 second block of data packets is created then sent, a third 30 second block of data packets is created then sent and so on. This helps facilitate maintaining the integrity of the data so that if there is a connection loss during transmission of the second 30 second block of data packets, no other data shall be transmitted until the connection has been reestablished. Upon reestablishing the connection, the entire second 30 second block of data packets shall be sent again and a third 30 second block of data packets will then be sent behind the second 30 second block of data packets in the previously defined sequence.

Next, the data for each service is displayed in a visualizer to facilitate graphic representation of captured patient data 340. Next the system checks to determine if the communications network is online or available 342. If the network is available the patient workstation synchronizes and transmits patient data with the central server 344.

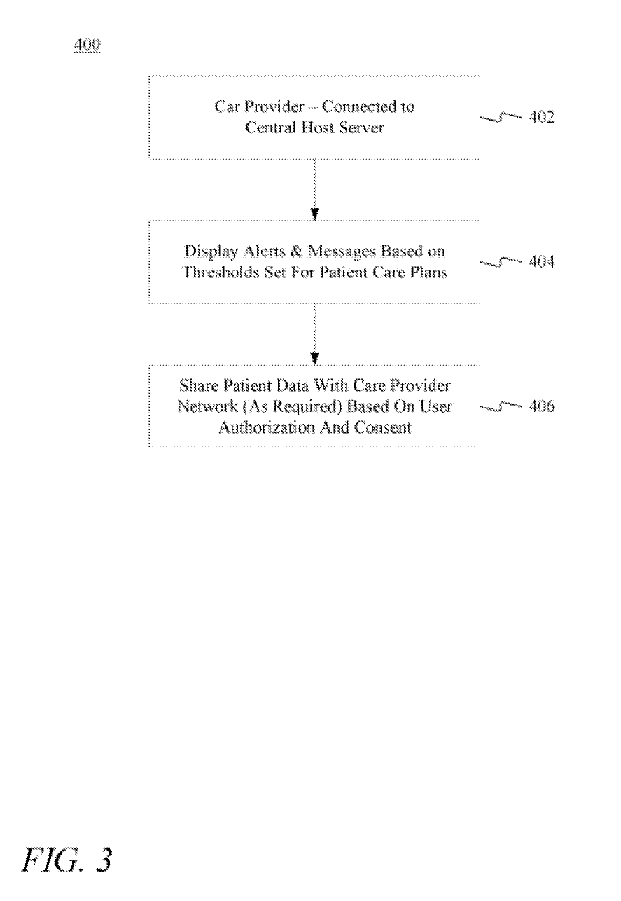

The central server 344 serves as a centralized data repository to which health care providers and other individuals who have been granted access authorization and consent by the patient to certain data files may connect and gain access to information to which they have authorization. As illustrated in FIG. 3, health care providers may connect to the central server 402. Connection may occur via WAN, but is generally done via a web based Internet connection. The application that manages connection to the host server is simply a web browser that individuals enter and gain access to in response to the entry of their respective credentials. Upon gaining access to the web browser, the user receives displays, alerts and messages based on their respective access authorization and consent previously defined by the patient 404. The web browser facilitates access to the centralized data repository by allowing users to login and gain access to files based on the authorization and consent provided a user by the patient 406. The health care provider seeking access to the central server may be a network of care providers including any of the following individuals: nurse, primary physician, pharmacist, family members, etc. These individuals each have access to certain subsets of the patient data based on the authority assigned at the access authorization and consent previously defined 406.

A medical plan decision module is a rule based engine that is continuously processing data representative of an existing medical plan, patient environmental data, patient physiological data and data associated with how the patient is following the plan. The medical plan decision module located on the central server processes this data that is being received from the patient station and continuously modifies the medical plan in view of the data received.

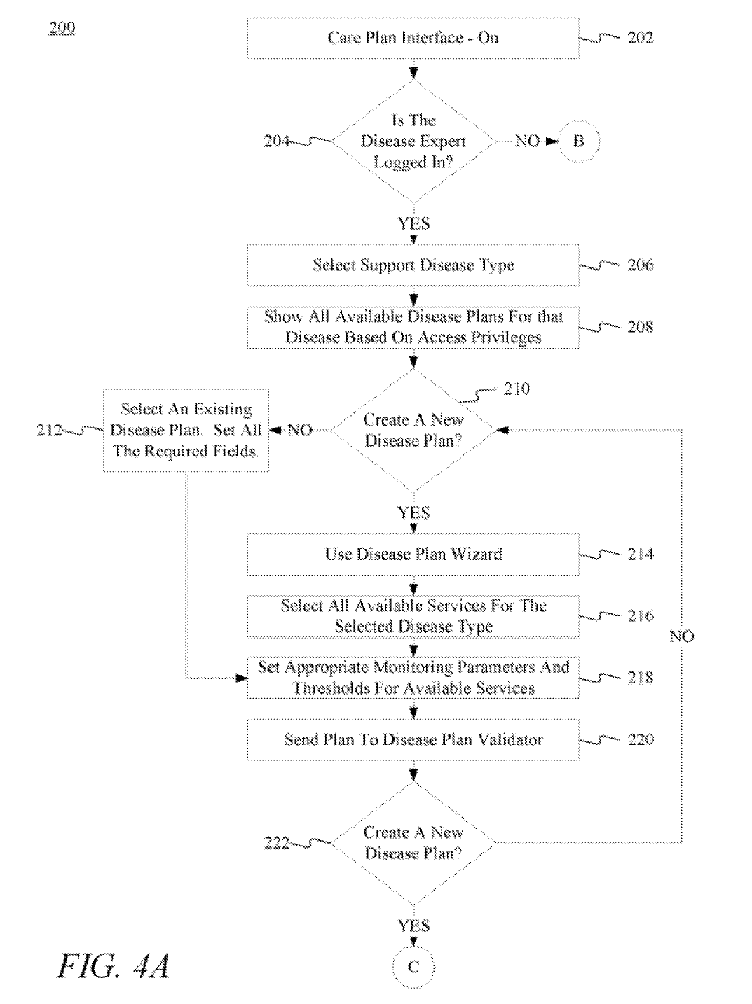

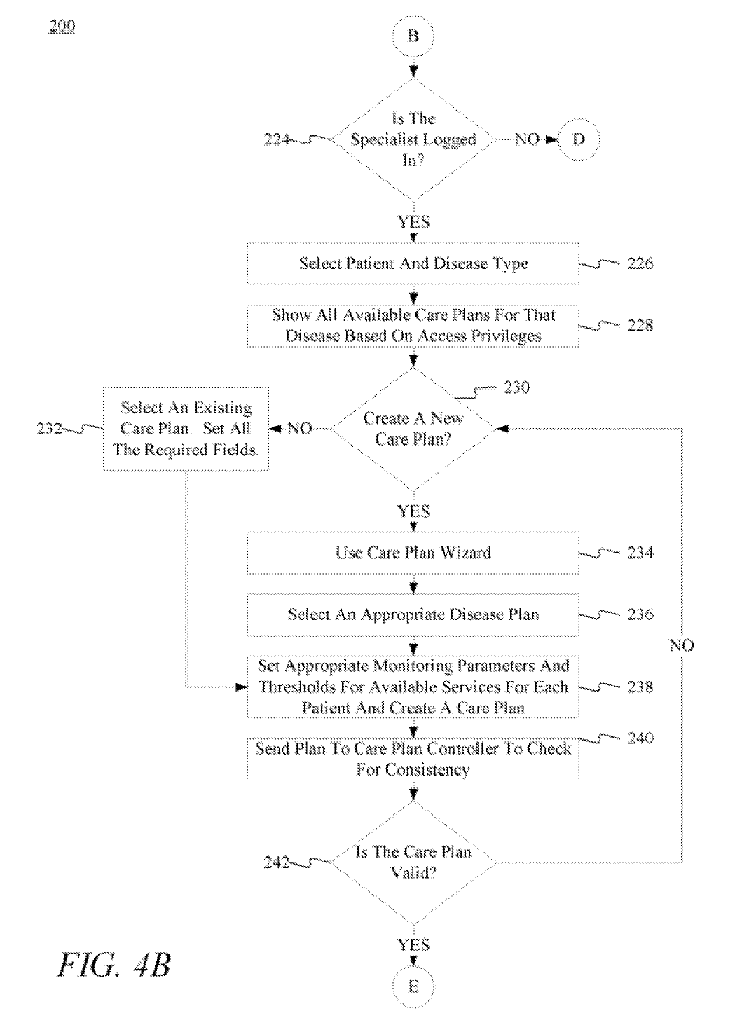

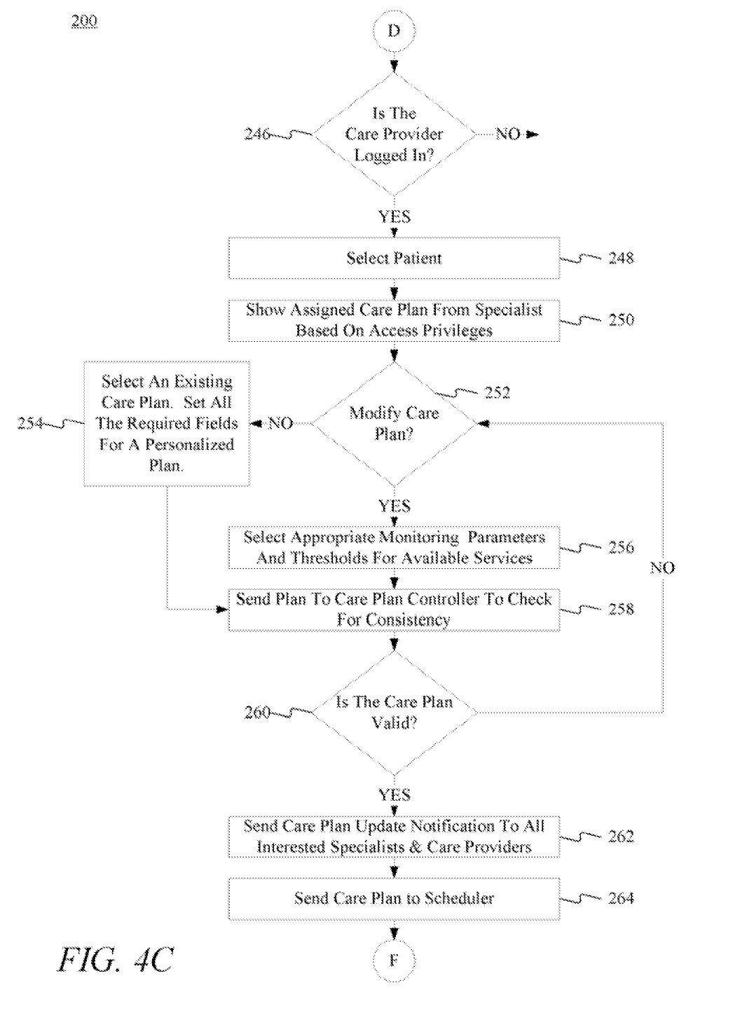

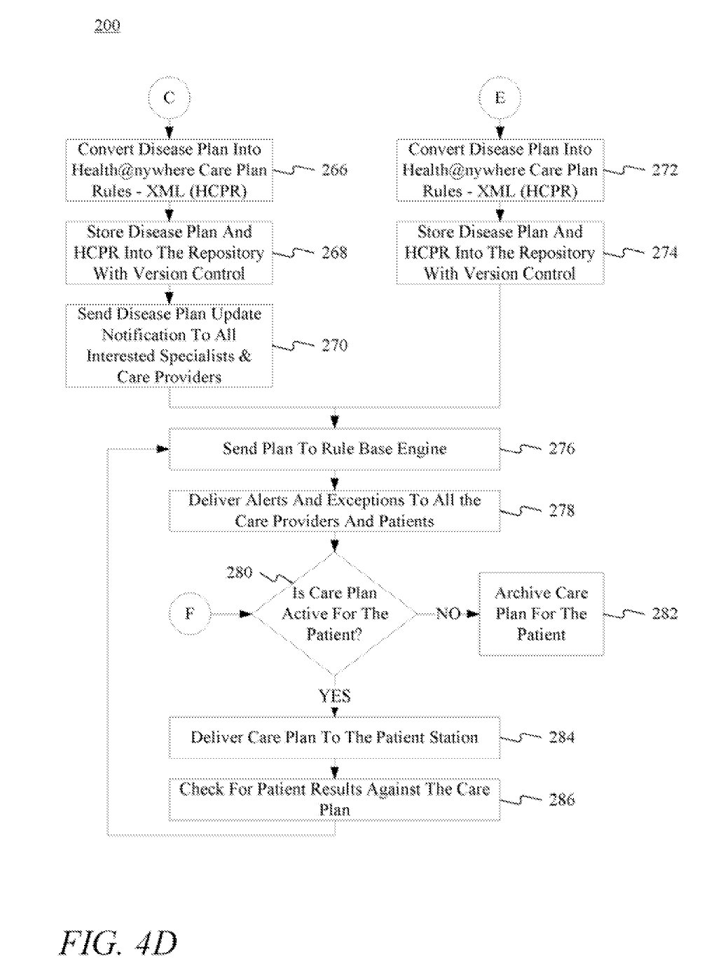

Referring to FIG. 4A-4D, the operation of the medical plan decision module is illustrated. First, a determination is made as to whether the care plan interface is turned on 202. Next, a determination is made as to whether the disease expert is logged in 204. A disease expert is an individual that describes care plans for specific diseases. Disease experts provide a medical plan template for specific diseases and deliver them to hospital professionals for use. For example, an endocrinologist would receive a medial plan template from a disease expert use it for patients that have the associated disease for which the medical plan is to treat. Following disease expert login, the disease expert engages the disease plan wizard which is a browser interface that allows the disease expert to select support for a disease type 206 which will show all available disease plans for the disease selected based on access privileges 208. Next, the interface allows the disease expert to create new plan 210 through use of the disease plan wizard 214. If the disease expert does not need to create a new disease plan, they select an existing disease plan and set all the required fields within the plan such as disease definition, required vital signs monitoring parameters, medications parameters, and nutrition parameters. Physical activity parameters, questionnaire parameters, wound management parameters, environmental sensor parameters, virtual visit assessment parameters, and physical visit assessment parameters.

During use of the disease wizard interface 214, the disease expert is allowed to select all the available services for the selected disease type 216, for example medication management, vital signs monitoring, video visits, questionnaires, etc. Next, the disease expert sets the appropriate monitoring parameters and thresholds for available services 218. For example, level of glucose has to be within 10 and 13. The medications have to be 3 dosages at 15 milligrams. All of those parameters have to be entered there. Next, the actual plan is sent to the disease plan validator 220 which checks whether the disease plan is valid. The disease plan validator checks the validity of the disease plan and makes sure it is complete before inserting it into the Care Plan Rule Base Engine. It also ensures that the disease plan can be converted into the Care Plan module Rules language. If the disease plan is valid, a new disease plan is created 222 and as illustrated in FIG. 4c, converted into Care Plan module Rules language 266 and stored in the repository within a central server 268. Next, a notification is sent to all the interested specialists and providers to let them know that a new disease plan is in the system, whole and modified 270. The new disease plan is also sent to the Rule based engine 276.

Referring to FIG. 4B, a determination is made as to whether the disease specialist is logged in 224, if there is not a disease specialist logged in, a determination is made as to whether a care provider is logged in 246. If a disease specialist is logged in 234, the disease plan wizard allows the disease specialist to select a patient and a disease type 226. Next the disease specialist reviews all available care plans for the disease type selected based on access privileges 228. Next, the interface allows the disease specialist to create new care plan 230 through use of the Care Plan Wizard 234. If the disease expert does not need to create a new care plan 232, they select an existing care plan 236 and set all the appropriate monitoring parameters and thresholds for available services for each patient and create a care plan 238. The Care Plan Wizard identifies an appropriate disease plan for a patient, identifies all subscribed services for a patient, creates a care plan by setting parameters for subscribed services, identifies all alert conditions based on thresholds, sets up notification criteria for dashboard view and assigns the care plan will be stored patient. Next, a notification is sent to the care plan controller to check for consistency 240 and make sure everything is valid. If the care plan is valid 242 the care plan will be stored in the XML log schema format in the server and database 272. Next an update notification is sent to the care providers indicating that this specialist has not modified and made changes to the patient's care plan. Then it is sent to the rule base engine repository with version control 274.

Referring to FIG. 4C, a determination is made as to whether a care provider is logged in 246. If there is a care provider logged in, the care plan wizard allows the care provider to select a patient 248. Next the care provider is shown the assigned care plan from the specialist based on access privileges 250. Next, the interface allows the care provider to modify care plan 252 through use of the Care Plan Wizard 234. If the care provider to modify care plan 252 through use of the Care Plan Wizard 234. If the care provider does not need to modify the care plan 254, they select an existing care plan 236 and set all the appropriate fields for a personalized plan. If the care plan provider modifies the plan, they select appropriate monitoring parameters and thresholds for available services 256. Next, they send the care plan to the care plan controller to check the care plan for consistency 258. The care plan controller checks the validity of the care plan, ensures that there is not conflict with the parameters set by the disease plan expert and makes sure the care plan is complete before inserting it into the care plan rule base engine. The care plan controller also ensures that the disease plan can be converted into the XML log schema format.

Next, a determination is made as to whether the Care Plan is valid 260, if the care plan is not valid, it must be modified again by the care plan provider 252 until it is valid. After the plan is valid, an update notification is sent to all interested specialist and care providers 262. The care plan is also sent to the Care Plan Scheduler 264. At this point determination is made as to whether the care plan is active for the patient 280. If the plan is active, it is delivered to the patient station 284. Next, the system checks for results against the care plan 286, and send the plan back to the rule base engine 276, which delivers alerts and exceptions to all the care providers and patients 278. The system checks for results against the care plan 286, and send the plan back to the rule base engine 276 for assessment in view of patient data received from the patient station and thereby changes the care plan in view of plan parameters and ranges previously define.

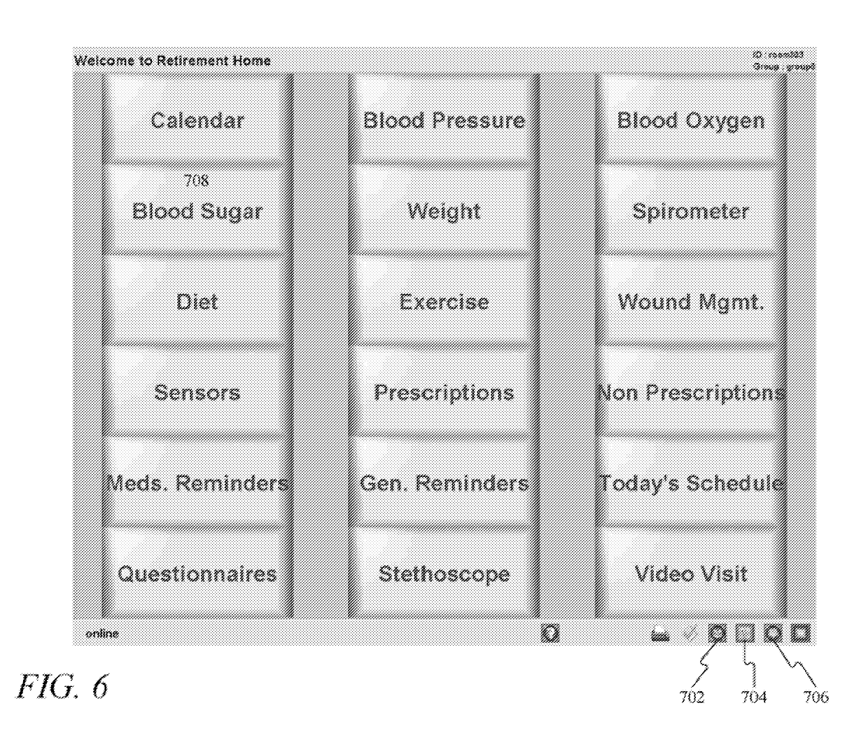

In an example of using systems and methods consistent with embodiments of the present invention to transmit data representative of a patient's environment from a patient health station to which a plurality of environmental sensors aware operatively connected in order to facilitate automatic transmission of patient environment data, the patient engages the system by logging into the patient station. FIG. 4 illustrates a login screen 700, from which the patient logs onto a website with a secure login ID and password in order to create a session. Following login, the patient is allowed to access the welcome screen 710 illustrated in FIG. 6. The welcome screen illustrates the icons for each service to which a patient may subscribe. The icons that are active are controlled by the services that a patient requires as a result of an illness. The icon 702 is a link to a speech recognition application which may be turned on by engaging icon 702. Engaging icon 702 will actually activate an automatic speech recognition engine which allows the patient to order all the commands such as calendar, weight, diet, exercise, instead of by engaging the associated icons. Engaging icon 704 on the welcome screen will activate a status bar which may be used to change the font, the colors, and the backgrounds of the interface. Engaging icon 706 on the welcome screen will initiate a display box illustrating who you are and the server to which you are connected. The server to which the user is connected is important because in some instances the user may be connected to a healthcare provider server and in others the user may be connected to the main central host server.

Of the icons illustrated in FIG. 6, in most instances, all of these icons will never be turned on because most patients will not subscribe to ever service. The icons that are turned on depend on what disease a patient has and the services the patient has subscribed to. Subscription and service setup is performed by a care provided at a nurse station. For example, patient Smith is going to utilize the system. The first thing that happens is that a care provider sets up a profile for Smith on the nurse station. Following the creation of a patient profile and record on the nurse station, the profile is saved on the central server. Next the patient is provided with a patient station, for example a tablet PC, and upon activating the tablet it communicates with the server and pulls down the profile. The profile facilitates activation of respective icons and everything a care provider has set up for the patient at the nurse station. The patient station may be any kind of computing apparatus so long as it has a processor, memory and an input device.

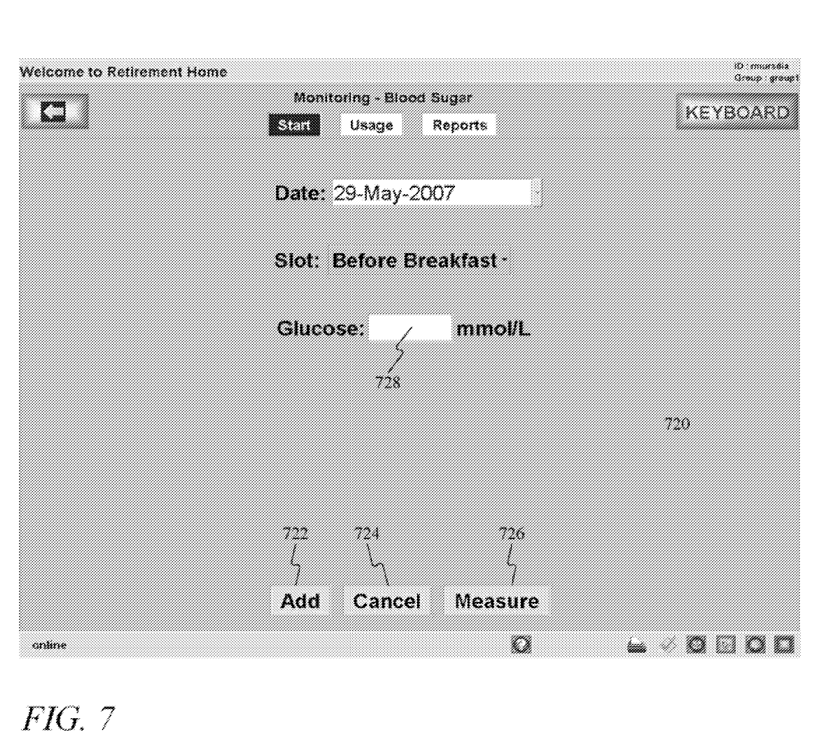

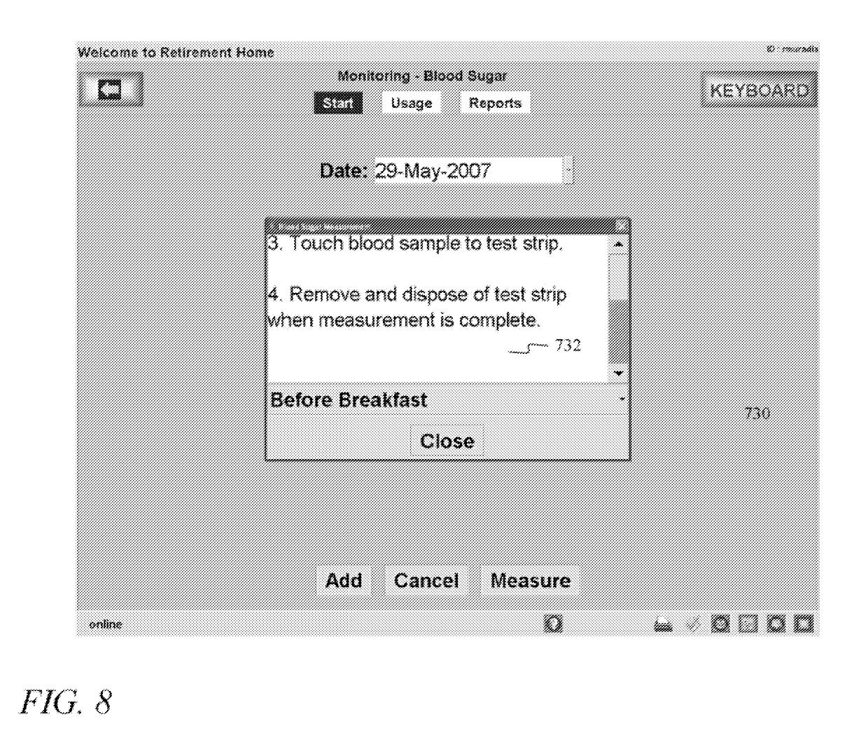

Upon initiating the blood sugar icon 708, the blood sugar monitoring screen 720 shown in FIG. 7 is illustrated. The blood sugar monitoring screen 720 provides 3 option, add 722, cancel 724, and measure 726. Upon engaging the measure icon 726, the blood sugar monitoring screen 730 that is displayed is illustrated in FIG. 8. This screen provides instructions on how to take a measurement 732. So with instructions written there, you can just play them back and hear them. Patient simply follows the instructions, and soon as blood sugar level is captured, it will be pushed on to the field 728 illustrated on the blood sugar monitoring screen 720 shown in FIG. 7. If the wireless link to the blood glucose monitor is not working, the user may alternatively initiate the keyboard button 729, which will cause a small keyboard to launch whereby the patient may read the glucose level and manually enter the data.

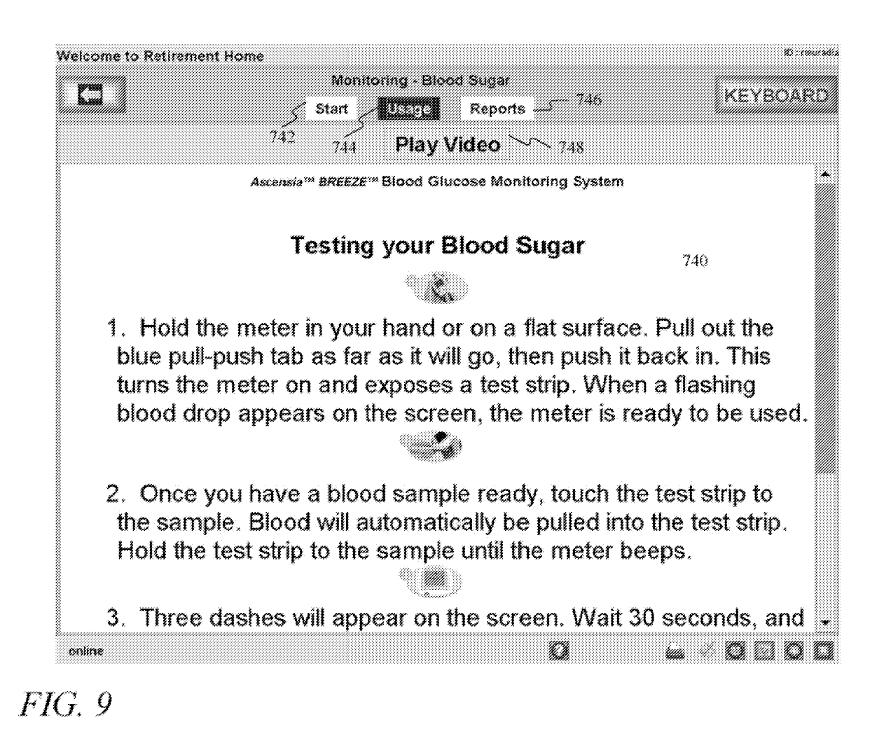

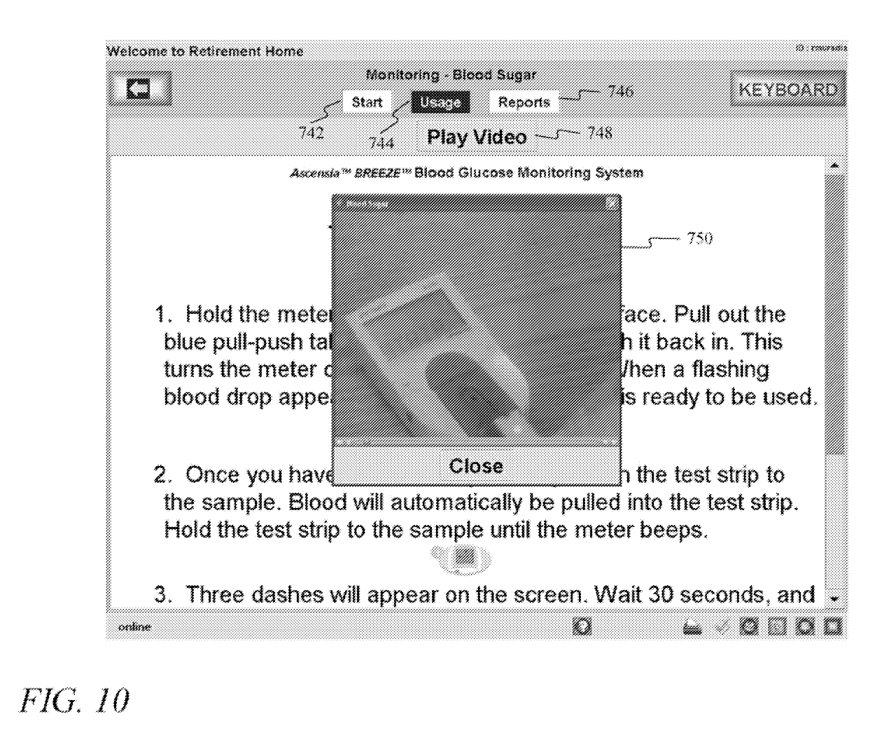

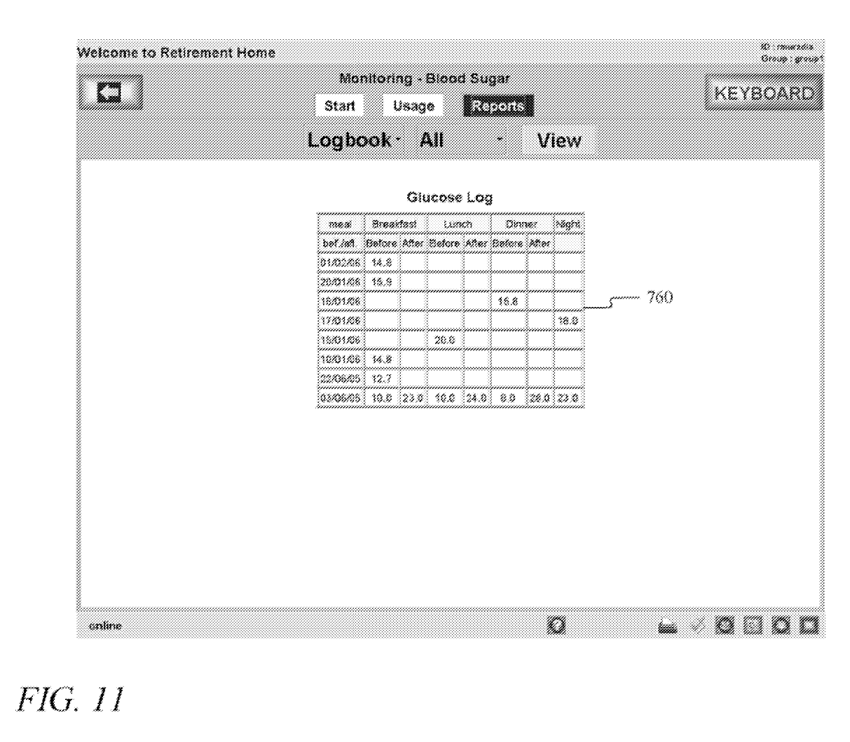

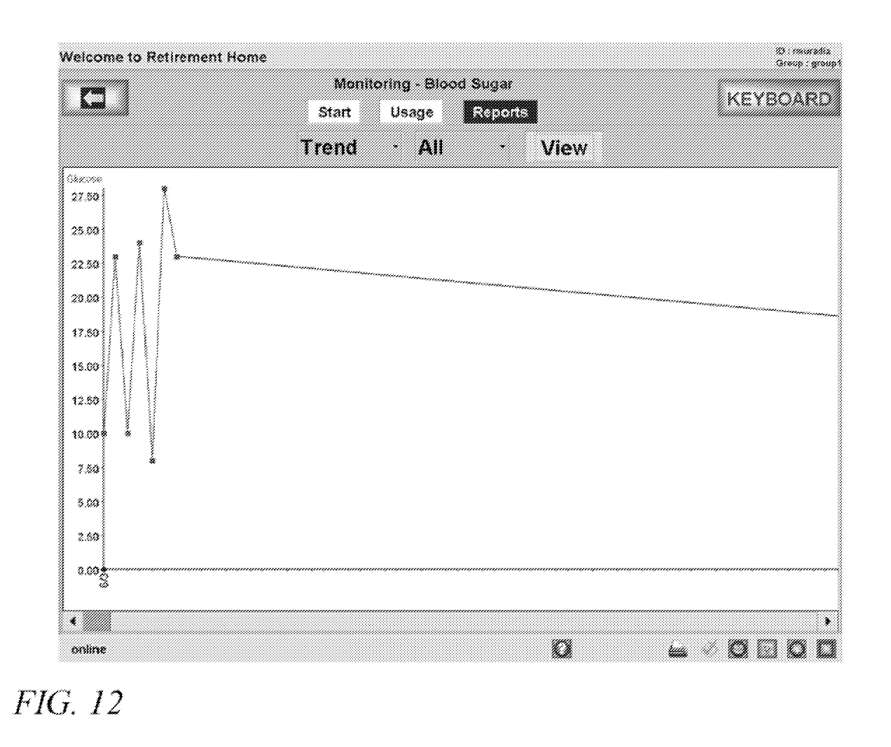

As illustrated in FIG. 9, if the patient presses the usage button 744 the instructions on the device and how it's to be use are presented. The patient may read the instructions or access video instruction by engaging the play video icon 748, which initiates a video box 750 illustrated in FIG. 10. Upon completion of gathering measurements, the patient may elect to have reports prepared and as illustrated in FIG. 11, the patient or care provider is allowed to review the patient's log book. FIG. 12 also illustrates the ability to graph the measurement in a chart.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

What is claimed is:

1. A method comprising:
providing a medical treatment plan;
acquiring medical data using a medical measuring system in a home of a patient to provide medical data;
transmitting the medical data to a remote server;
reviewing the medical data at the remote server;
determining that the medical data is indicative of a first condition;
choosing a second, other medical treatment plan in dependence upon the first condition absent a face to face consultation with a medical professional.

2. A method according to claim 1 comprising:
upon determining that the medical data is indicative of an ailment, identifying the ailment; and,
obtaining the advice of a specialist with regards to choosing the second medical treatment plan.

3. A method according to any of claims 1 and 2 comprising:
providing a skilled medical professional, and wherein determining that the medical data is indicative of an ailment is carried out in dependence upon information provided by the skilled medical professional.

4. A method according to any one of claims 2 and 3 comprising:
upon identifying the ailment, providing a specialist that is knowledgeable regarding the ailment; and
obtain an opinion from the specialist regarding the identification of the ailment.

5. A method according to claim 4 wherein the specialist chooses the second, other medical plan.
